(19) United States
(12) Patent Application Publication
(10) Pub. No.: US 2024/0318079 A1
(43) Pub. Date: Sep. 26, 2024

(54) ETCHANT COMPOSITION FOR PRODUCING GRAPHENE WITH LOW SHEET RESISTANCE

(71) Applicant: GrapheneLab.Co.,Ltd., Hwaseong-si (KR)

(72) Inventors: Jong Taik MOON, Seongnam-si (KR); Young Duck KWON, Gwangmyeong-si (KR); Byong Wook YOO, Namyangju-si (KR); Sang Min LEE, Yongin-si (KR); Seung Il MOON, Ansan-si (KR); Ki Soo KIM, Seongnam-si (KR); Gyu Hyun LEE, Yongin-si (KR); Da Som HYUN, Osan-si (KR); Su Jin SHIM, Osan-si (KR)

(21) Appl. No.: 18/735,108

(22) Filed: Jun. 5, 2024

Related U.S. Application Data
(63) Continuation of application No. PCT/KR2022/001082, filed on Jan. 21, 2022.

(30) Foreign Application Priority Data
Dec. 27, 2021 (KR) 10-2021-0188779

(51) Int. Cl. C09K 13/10

(52) U.S. Cl. CPC C09K 13/10

(57) ABSTRACT

An etchant composition for preparing graphene having low sheet resistance includes sulfuric acid, hydrogen peroxide, an N-heterocyclic aromatic compound, aromatic boric acid, and purified water. The etchant composition exhibits an effect of remarkably reducing the sheet resistance of graphene produced through chemical vapor deposition (CVD).

### CROSS REFERENCE TO RELATED APPLICATIONS

This application is a Continuation of PCT/KR2022/001082 filed Jan. 21, 2022, which claims priority from Korean Application No. 10-2021-0188779 filed Dec. 27, 2021. The aforementioned applications are incorporated herein by reference in their entireties.

### TECHNICAL FIELD

The present disclosure relates to an etchant composition for preparing graphene having a low sheet resistance and, more particularly, to an etchant composition having an effect of significantly reducing the sheet resistance of graphene produced through chemical vapor deposition (CVD).

### RELATED ART

Graphene produced through chemical vapor deposition (CVD) is usually prepared from copper or nickel copper foil. Therefore, etching copper or nickel is required for graphene production. Nickel is advantageous in forming multi-layer graphene, and copper is advantageous in forming single-layer graphene. Therefore, etching a copper thin film is very important in the process of producing graphene.

Graphene grown on a copper thin film can be etched by various methods. After graphene is grown on top of a copper thin film through CVD, a transfer process is required to for devices using an etchant using ammonium persulfate (APS), cerium ammonium nitrate (CAN), or nitric acid. The transfer process includes three steps: applying a polymer thin film on top of graphene, etching a copper thin film, and cleaning the resulting structure.

The etchant for copper most commonly used is an aqueous solution of iron chloride (FeCl₃) having a mass concentration of 30%, an aqueous solution of ammonium cerium nitrate, and an aqueous solution of a mixture of acetic acid and nitric acid.

Although the iron chloride aqueous solution exhibits a fast etching rate, there is a problem in that cleaning takes a long time and a lot of metal residues remain under the graphene.

The cerium ammonium nitrate aqueous solution has a problem in that the copper etching rate is very low and the cerium metal remains between the graphene grains or under the graphene.

The aqueous solution of acetic acid and nitric acid has a disadvantage that intercalation occurs at the graphene grain boundary during etching, and graphene is oxidized.

Since graphene has defects such as grain boundaries, conventional graphene prepared using the above-described etchants has a problem of very high sheet resistance. For example, a single graphene layer exhibits 800 to 1 KΩ/sq 102 (Since graphene has defects such as grain boundaries, conventional graphene prepared using the above-listed etchants has a problem of very high sheet resistance, and it exhibits 800 to 1K Ω/sq based on one layer (Direct Probing of 1/f Noise Origin with Graphene Multilayers: Surface vs. Volume, Guanxiong Liu, 2013, Applied Physics Letter, 102).

In order to solve the above problems, recently, a method of performing doping after etching has been used. Even though doping is performed after etching, the sheet resistance of the graphene produced is 250 to 300 Ω/sq which is still high.

### SUMMARY

The objective of the present disclosure is to provide an etchant composition for preparing graphene having a low sheet resistance, the composition having an effect of remarkably reducing the sheet resistance of graphene produced through chemical vapor deposition.

The objective of the present disclosure is achieved by providing an etchant composition for preparing graphene having a low sheet resistance, the etchant composition including sulfuric acid, hydrogen peroxide, an N-heterocyclic aromatic compound, aromatic boric acid, and purified water.

According to a preferred feature of the present invention, the etchant composition may include 9 to 11 wt % of sulfuric acid, 3 to 4 wt % of hydrogen peroxide, 2 to 4 wt % of an N-heterocyclic aromatic compound, 1.5 to 2.5 wt % of aromatic boric acid, and the remaining amount of purified water.

According to a more preferred feature of the present invention, the etchant composition may include 10 wt % of the sulfuric acid, 3.5 wt % of hydrogen peroxide, 3 wt % of the N-heterocyclic aromatic compound, 2 wt % of the aromatic boric acid, and the remaining amount of the purified water.

According to an even more preferred feature of the present invention, the N-heterocyclic aromatic compound may be composed of benzoimidazole or benzotriazole.

According to a still more preferred feature of the present invention, the aromatic boric acid may be composed of phenyl boric acid.

The etchant composition for producing graphene having a low sheet resistance, according to the present disclosure, exhibits an excellent effect of remarkably reducing the sheet resistance of graphene prepared through chemical vapor deposition.

### BRIEF DESCRIPTION OF THE DRAWINGS

FIG. 1 is a graph showing changes in sheet resistance of graphene samples produced in Comparative Examples 1 to 4; and

FIG. 2 is a graph showing sheet resistance of each graphene sample produced in Example 1, Comparative Example 1, and Comparative Examples 5 to 9.

### DETAILED DESCRIPTION

Hereinafter, a preferred embodiment of the present invention and the physical properties of each component will be described in detail. The description is to help those who are ordinarily skilled in the art to which the present disclosure pertains easily carry out the invention and is not intended to limit the technical spirit and scope of the present disclosure.

In one embodiment of the present disclosure, an etchant composition for preparing graphene having a low sheet resistance includes sulfuric acid, hydrogen peroxide, an N-heterocyclic aromatic compound, aromatic boric acid, and purified water. Specifically, the etchant composition includes 9 to 11 wt % of the sulfuric acid, 3 to 4 wt % of the hydrogen peroxide, 2 to 4 wt % of the N-heterocyclic aromatic compound, 1.5 to 2.5 wt % of the aromatic boric acid, and the remaining amount of the purified water.

The sulfuric acid is contained in an amount of 9 to 11 wt % and serves to remove a copper oxide film present on the surface of a seed layer to be etched, and to promote etching.

When the content of the sulfuric acid is less than 9 wt %, the etching rate of copper is low and thus the time required for the seed layer removal process is excessively long. When the content of the sulfuric acid exceeds 11% by weight, the etching rate, the etching effect, and the undercut inhibition effect are not significantly improved, the manufacturing cost is increased, the amount of wastewater generated is increased. Therefore, the content of the sulfuric acid exceeding 11% by weight is not desirable.

The hydrogen peroxide is contained in an amount of 3 to 4 wt % and serves as an oxidizing agent to oxidize copper (Cu) contained in the seed layer. A copper oxide (CuO) film is formed on the surface of the seed layer in contact with the etchant prepared through the method of the present disclosure.

When the content of hydrogen peroxide is less than 3 wt %, the oxidizing power of the etchant composition prepared by the method of the present disclosure is weak to reduce etching performance. When the content of hydrogen peroxide exceeds 4 wt %, the oxidizing power with respect to copper is excessively strong, and the etching rate is excessively high to cause side attack and undercut of the copper seed layer.

The N-heterocyclic aromatic compound is contained in an amount of 2 wt % to 4 wt % and serves to improve the etching rate in the vertical direction of the copper thin film and to reduce the sheet resistance of graphene produced through chemical vapor deposition.

In particular, when the etchant is sprayed to the surface of the seed layer from above, the N-heterocyclic aromatic compound accelerates etching in the spray direction.

In this case, the N-heterocyclic aromatic compound is preferably benzoimidazole or benzotriazole.

When the content of the N-heterocyclic aromatic compound is less than 2 wt %, the above effect is insignificant. On the other hand, when the content of the N-heterocyclic aromatic compound exceeds 4 wt %, the effect is not significantly improved and the effect of reducing the sheet resistance of graphene is reduced due to an excessive amount thereof with respect to the aromatic boric acid.

The aromatic boric acid is contained in an amount of 1.5 wt % to 2.5 wt % and serves to significantly reduce the sheet resistance of graphene formed through chemical vapor deposition. When the content of the aromatic boric acid is less than 1.5 wt %, the above effect is insignificant. When the content of the aromatic boric acid exceeds 2.5 wt %, the effect of reducing the sheet resistance of graphene is reduced.

In this case, the aromatic boric acid is preferably phenyl boric acid, and the content of the aromatic boric acid is most preferably 66.6 parts by weight with respect to 100 parts by weight of the N-heterocyclic aromatic compound.

Hereinafter, the etchant composition preparation method of the present disclosure and the physical properties the etchant composition prepared by the method will be described with reference to examples below.

### Preparation Example 1

10 wt % of sulfuric acid, 3.5 wt % of hydrogen peroxide, 3 wt % of N-heterocyclic aromatic compound (benzotriazole), 2 wt % of aromatic boric acid (phenyl boric acid), and the remaining amount of purified water were mixed and stirred at a speed of 150 rpm for 10 minutes to obtain an etchant composition.

### Preparation Example 2

10 wt % of sulfuric acid, 3.5 wt % of hydrogen peroxide, 0.75 wt % of N-heterocyclic aromatic compound (benzotriazole), and the remaining amount of purified water were mixed and stirred at a speed of 150 rpm for 10 minutes to obtain an etchant composition.

### Preparation Example 3

10 wt % of sulfuric acid, 3.5 wt % of hydrogen peroxide, 1.50 wt % of N-heterocyclic aromatic compound (benzotriazole), and the remaining amount of purified water were mixed and stirred at a speed of 150 rpm for 10 minutes to obtain an etchant composition.

### Preparation Example 4

10 wt % of sulfuric acid, 3.5 wt % of hydrogen peroxide, 2.25 wt % of N-heterocyclic aromatic compound (benzotriazole), and the remaining amount of purified water were mixed and stirred at a speed of 150 rpm for 10 minutes to obtain an etchant composition.

### Preparation Example 5

10 wt % of sulfuric acid, 3.5 wt % of hydrogen peroxide, 3.0 wt % of N-heterocyclic aromatic compound (benzotriazole), and the remaining amount of purified water were mixed and stirred at a speed of 150 rpm for 10 minutes to obtain an etchant composition.

### Preparation Example 6

10 wt % of sulfuric acid, 3.5 wt % of hydrogen peroxide, 3 wt % of N-heterocyclic aromatic compound (benzotriazole), 1 wt % of aromatic boric acid (phenyl boric acid), and the remaining amount of purified water were mixed and stirred at a speed of 150 rpm for 10 minutes to obtain an etchant composition.

### Preparation Example 7

10 wt % of sulfuric acid, 3.5 wt % of hydrogen peroxide, 1 wt % of N-heterocyclic aromatic compound (benzotriazole), 1 wt % of aromatic boric acid (phenyl boric acid), and the remaining amount of purified water were mixed and stirred at a speed of 150 rpm for 10 minutes to obtain an etchant composition.

### Preparation Example 8

10 wt % of sulfuric acid, 3.5 wt % of hydrogen peroxide, 1 wt % of N-heterocyclic aromatic compound (benzotriazole), 2 wt % of aromatic boric acid (phenyl boric acid), and the remaining amount of purified water were mixed and stirred at a speed of 150 rpm for 10 minutes to obtain an etchant composition.

### Preparation Example 9

10 wt % of sulfuric acid, 3.5 wt % of hydrogen peroxide, 1 wt % of N-heterocyclic aromatic compound (benzotriazole), 3 wt % of aromatic boric acid (phenyl boric acid), and the remaining amount of purified water were mixed and stirred at a speed of 150 rpm for 10 minutes to obtain an etchant composition.

### Preparation Example 10

10 wt % of sulfuric acid, 3.5 wt % of hydrogen peroxide, 1 wt % of N-heterocyclic aromatic compound (benzotriazole), 4 wt % of aromatic boric acid (phenyl boric acid), and the remaining amount of purified water were mixed and stirred at a speed of 150 rpm for 10 minutes to obtain an etchant composition.

### Example 1

Argon and hydrogen were made to flow along the surface of copper foil to oxide the surface of copper foil. Next, methane gas and hydrogen gas were injected at a temperature of 1000° C. to grow graphene, followed by cooling of the grown graphene. Next, a thermal release film (TRF) was formed thereon, and the copper foil undergoes etching with the etchant composition prepared in Example 1, sequentially followed by cleaning with ultrapure purified water, drying with nitrogen, coating with polyethylene terephthalate, and removal of the TRF at a temperature of 120° C. Through these steps, graphene transferred to polyethylene terephthalate was prepared.

### Comparative Example 1

Graphene was prepared in the same manner as in Example 1, except that the etchant composition prepared in Preparation Example 2 was used.

### Comparative Example 2

Graphene was prepared in the same manner as in Example 1, except that the etchant composition prepared in Preparation Example 3 was used.

### Comparative Example 3

Graphene was prepared in the same manner as in Example 1, except that the etchant composition prepared in Preparation Example 4 was used.

### Comparative Example 4

Graphene was prepared in the same manner as in Example 1, except that the etchant composition prepared in Preparation Example 5 was used.

### Comparative Example 5

Graphene was prepared in the same manner as in Example 1, except that the etchant composition prepared in Preparation Example 6 was used.

### Comparative Example 6

Graphene was prepared in the same manner as in Example 1, except that the etchant composition prepared in Preparation Example 7 was used.

### Comparative Example 7

Graphene was prepared in the same manner as in Example 1, except that the etchant composition prepared in Preparation Example 8 was used.

### Comparative Example 8

Graphene was prepared in the same manner as in Example 1, except that the etchant composition prepared in Preparation Example 9 was used.

### Comparative Example 9

Graphene was prepared in the same manner as in Example 1, except that the etchant composition prepared in Preparation Example 10 was used.

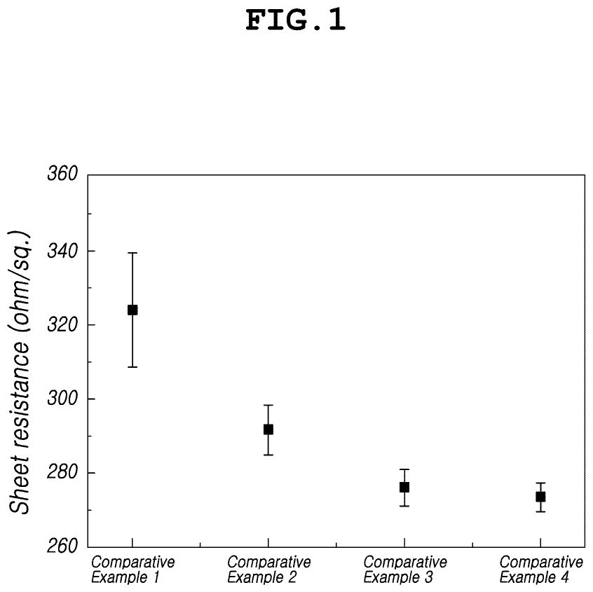

The sheet resistance of the graphene prepared in each of Comparative Examples 1 to 4 was measured. The results are shown in FIG. 1 below.

As shown in FIG. 1 below, when the etchant in which the N-heterocyclic aromatic compound component is increased is used, the sheet resistance of the graphene produced is reduced. However, when the N-heterocyclic aromatic compound component is further increased, the sheet resistance is not lowered to below 270 ohm/sq.

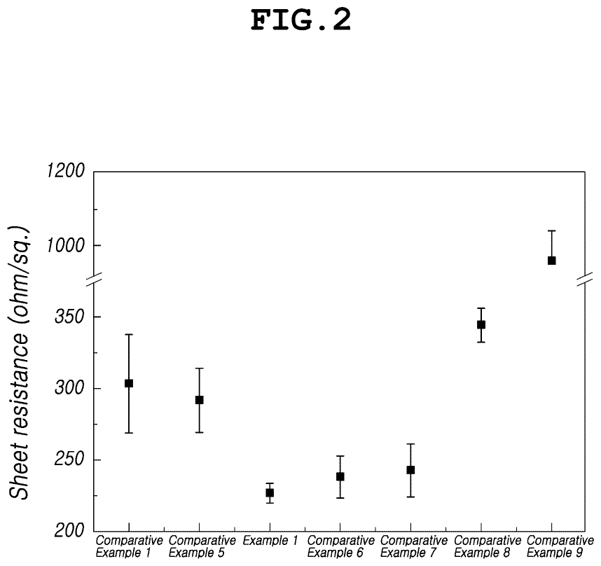

The sheet resistance of the graphene prepared in each of Example 1, Comparative Example 1, and Comparative Examples 5 to 9 was measured. The results are shown in FIG. 2 below.

As shown in FIG. 2 below, the etchant using both the N-heterocyclic aromatic compound and the aromatic boric acid more effectively reduced the sheet resistance of the graphene than the etchant using only the N-heterocyclic aromatic compound. Especially, in the case of Example in which he N-heterocyclic aromatic compound and the aromatic boric acid were mixed in a ratio of 3:2, the most excellent effect of reducing sheet resistance was exhibited.

In the case of Comparative Examples 8 to 9 in which the amount of the aromatic boric acid exceeds twice the amount of the N-heterocyclic aromatic compound, the sheet resistance of the prepared graphene was rather increased.

Accordingly, it is confirmed that the etchant composition according to the example of the present disclosure exhibits an excellent effect of remarkably reducing the sheet resistance of graphene prepared through chemical vapor deposition.

According to the present disclosure, it is possible to provide an etchant composition having an effect of remarkably reducing the sheet resistance of graphene produced through chemical vapor deposition.

What is claimed is:

1. An etchant composition for producing graphene with low sheet resistance, comprising:
sulfuric acid;
hydrogen peroxide;
an N-heterocyclic aromatic compound;
aromatic boric acid; and
purified water,
wherein the N-heterocyclic aromatic compound comprises benzoimidazole or benzotriazole.

2. The etchant composition according to claim 1, wherein the etchant composition comprises:
9 to 11 wt % of the sulfuric acid;
3 to 4 wt % of the hydrogen peroxide;
2 to 4 wt % of the N-heterocyclic aromatic compound;
1.5 to 2.5 wt % of the aromatic boric acid; and
the remaining proportion of the purified water.

3. The etchant composition according to claim 2, wherein the etchant composition comprises:
10 wt % of the sulfuric acid;
3.5 wt % of the hydrogen peroxide;
3 wt % of the N-heterocyclic aromatic compound;
2 wt % of the aromatic boric acid; and
the remaining proportion of the purified water.
